(19) United States
(12) Patent Application Publication
(10) Pub. No.: US 2024/0101427 A1
(43) Pub. Date: Mar. 28, 2024

(54) LOW TEMPERATURE PHOTOCHEMICAL PATTERNING OF CARBON NANO- AND MICROSTRUCTURES

(71) Applicant: University of Central Florida Research Foundation, Inc., Orlando, FL (US)

(72) Inventors: Laurene Tetard, Orlando, FL (US); Richard Blair, Orlando, FL (US)

(21) Appl. No.: 18/373,460

(22) Filed: Sep. 27, 2023

Related U.S. Application Data
(60) Provisional application No. 63/410,402, filed on Sep. 27, 2022.

(51) Int. Cl. C01B 32/15; B82Y 30/00; B82Y 40/00

(52) U.S. Cl. CPC C01B 32/15; B82Y 30/00; B82Y 40/00; C01P 2004/01; C01P 2006/40; C01P 2006/90

(57) ABSTRACT

This disclosure relates to a method of producing and patterning of well-defined nanoscale and microscale carbon structures with light using a defect-engineered photocatalyst.

### CROSS-REFERENCE TO RELATED APPLICATIONS

This application claims the benefit of priority to U.S. Non Provisional Patent Application No. 63/410,402, filed Sep. 27, 2022, the disclosure of which is incorporated herein by reference in its entirety.

### FIELD

This disclosure relates to a method of producing and patterning of well-defined nanoscale and microscale carbon structures with light using a defect-engineered photocatalyst.

### BACKGROUND

Carbon nanostructures, microstructures and derived heterostructures are used in plethora of applications including in medicine, energy devices, optoelectronics, transportation, and even sporting goods.

Numerous methods for generating carbon nanostructures have been reported. Nevertheless, a need for large-scale generation of carbon nanostructures remains. Conventional approaches to form carbon structures are highly energy intensive as they generally involve a pyrolysis step at high temperature. This energy expenditure is necessary to transform an organic precursor—either small molecules such as propene or methane or larger compounds such as biomass. In recent years, light-assisted synthesis has also been reported including laser ablation and laser chemical vapor deposition (LCVD). Still, both of these techniques require a high power laser to sufficiently break chemical bonds, typically above 500 mW.

A growth technique which can create carbon features of controllable dimensions, compositions and with controllable direction of growth but does not require high temperature will unlock many opportunities in material sciences and applications.

To that end, disclosed is a new growth technique that involves a low cost and readily accessible photocatalysts and a low-cost laser to grow carbon nano- and microstructures without the need for high temperatures.

### SUMMARY OF THE INVENTION

In one aspect, the invention provides for a method for producing a carbon nanostructure having controlled dimensions comprising:
a.) providing a two-dimensional catalyst having one or more variances; and
b.) exposing the surface of the catalyst to a light source in the presence of a carbon source to produce a carbon nanostructure at the site of exposure.

In some embodiments of the method for producing a carbon nanostructure having controlled dimensions, the two dimensional catalyst having one or more variances is a defect laden hexagonal boron nitride (h-BN), a two-dimensional boron produced through chemically etching an aluminum diboride (AlB₂) material, or a two-dimensional boron-based material in which the local environment of the boron atom includes variances produced by inclusion of a doping agent, induced strain, stacking with additional catalysts.

In still other embodiments of the method for producing a carbon nanostructure having controlled dimensions, the light source is a CO laser, a CO₂ laser, a Nd:YAG laser, a frequency doubled Nd:YAG laser, an argon fluoride laser, a xenon chloride laser, a xenon fluoride laser, a helium cadmium laser, a dye laser, a copper vapor laser, an argon laser, a helium neon laser, a krypton laser, a ruby laser, a Ti:sapphire laser, laser diodes, an alexandrite laser, a hydrogen fluoride laser, an erbium:glass laser, or solar illumination.

In yet other embodiments of the method for producing a carbon nanostructure having controlled dimensions, the carbon source is methane, ethane, or propane, propene, allene, propyne, cyclohexene, or carbon monoxide.

In still yet other embodiments of the method for producing a carbon nano structure having controlled dimensions, the light source is housed in a printing apparatus capable of producing a pattern of carbon nanostructures.

### BRIEF DESCRIPTION OF THE DRAWINGS

FIG. 1. A photograph showing an array of carbon columns produced on dh-BN using focused 532 nm illumination.

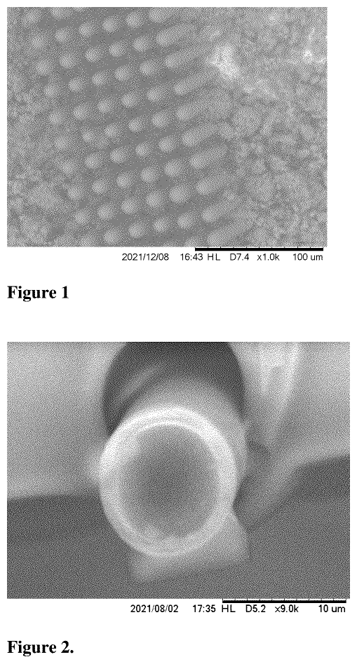

FIG. 2. A photograph showing a cross-section of a single carbon column shows good circularity and structure.

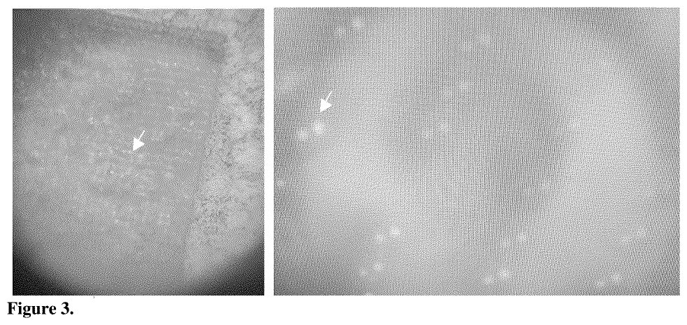

FIG. 3. Two photographs (regular and magnified) showing an array of carbon columns emitting white light (shown as small white dots).

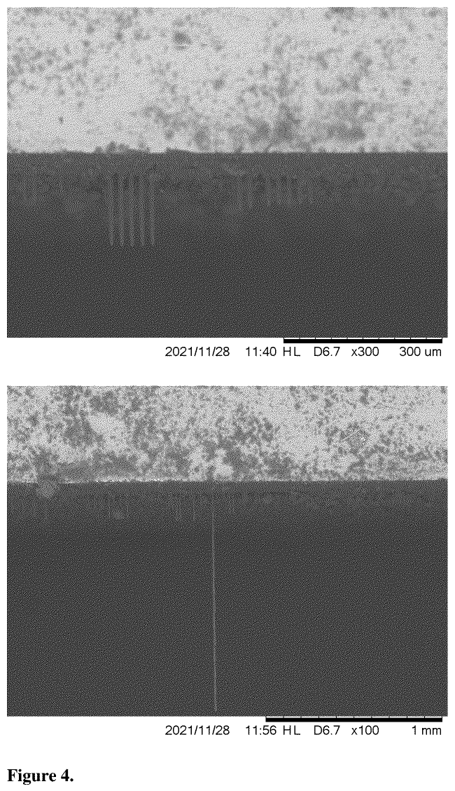

FIG. 4. Two photographs showing the effect of varying patterning parameters on the morphology of the structures produced.

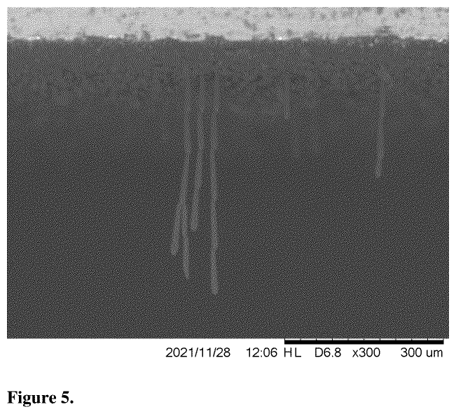

FIG. 5. A photograph showing an example of branched structure patterned with a 532 nm laser.

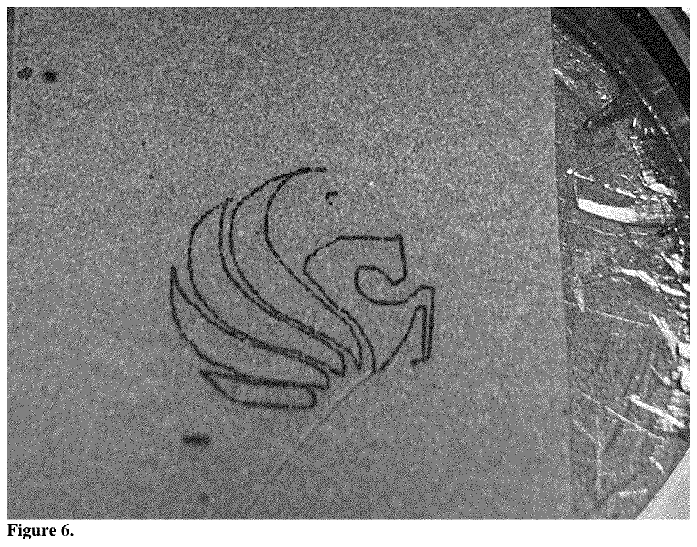

FIG. 6. A photograph showing the generation of a simple pattern produced by a focused 405 nm 350 mW laser on a positioned platform controlled via gcode.

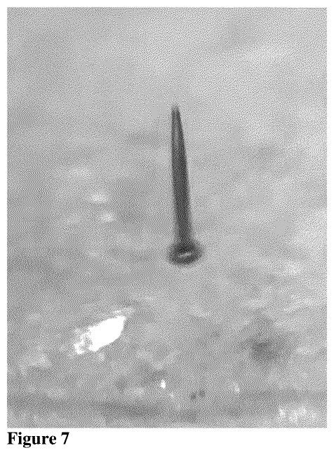

FIG. 7. A photograph of a single column grown on non-equilibrium boron produced through the wet chemical etching of AlB2 using methane and a focused 405 nm 350 mW laser.

FIG. 8a. A photograph depicting a rod according to the invention set up for electrical measurements as discussed in the Examples.

FIG. 8b. A photograph showing a rod according to the invention which was broken after passing current through the rod above the damage threshold.

FIG. 8c. A magnified view of the broken rod shown in FIG. 8b.

FIG. 8d. A photograph showing the same rod shown in FIG. 8a after passing current through the rod. The zoomed out dark areas show where resistive heating caused catastrophic failure.

FIGS. 9a and 9b. Graphs showing a power curve demonstrating the DC electrical properties of the rod shown in FIG. 8a.

FIGS. 10a and 10b. Graphs demonstrating the AC electrical properties of the rod shown in FIG. 8A. The graphs show that the rod has resistive, inductive, and capacitive properties and behaves an RLC circuit.

FIG. 11. A graphs depicting the complex impedance spectrum of a rod shown in FIG. 8a.

FIG. 12. A photograph showing a rod shown in FIG. 8a prior to testing which demonstrates the flexibility of the rod.

### DETAILED DESCRIPTION

For purposes of explanation and illustration, and not limitation, embodiments of a method of producing and patterning of well-defined nanoscale and microscale carbon structures with light using a defect-engineered photocatalyst in accordance with the disclosure are described herein with general reference to the attached drawings.

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures, and other references mentioned herein are expressly incorporated by reference in their entirety.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

All numerical values within the detailed description and the claims herein are modified by “about” or “approximately” the indicated value, and take into account experimental error and variations that would be expected by a person having ordinary skill in the art.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrases “at least one” and “one or more” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

“Substantially” or “essentially” means nearly totally or completely, for instance, 95%, 96%, 97%, 98%, 99% or greater of some given quantity.

“Substantially free” refers to the nearly complete or complete absence of a given quantity for instance, less than about 10%, 5%, 4%, 3%, 2%, 1%, 0.5% or less of some given quantity. For example, certain compositions may be “substantially free” of cell proteins, membranes, nucleic acids, endotoxins, or other contaminants.

Where the plural form of the word compounds, salts, polymorphs, hydrates, solvates and the like, is used herein, this is taken to mean also a single compound, salt, polymorph, isomer, hydrate, solvate or the like.

The compounds, compositions and materials according to the disclosure are preferably isolated in more or less pure form that is more or less free from residues from the synthetic procedure. The degree of purity can be determined by methods known to the chemist or pharmacist (see especially Remington's Pharmaceutical Sciences, 18^{th} ed. 1990, Mack Publishing Group, Enolo). Preferably the compounds are greater than 99% pure (w/w), while purities of greater than 95%, 90% or 85% can be employed if necessary.

Throughout this document, for the sake of simplicity, the use of singular language is given preference over plural language, but is generally meant to include the plural language if not otherwise stated. e.g., the expression “A method of treating a disease in a patient, comprising administering to a patient an effective amount of a compound of claim 1” is meant to include the simultaneous treatment of more than one disease as well as the administration of more than one compound of claim 1.

It should also be understood that, in certain methods described herein that include more than one step or act, the order of the steps or acts of the method is not necessarily limited to the order in which the steps or acts of the method are recited unless the context indicates otherwise.

### Method of Producing and Patterning of Well-Defined Nanoscale and Microscale Carbon Structures

This disclosure demonstrates a new growth technique that involves a low cost and readily accessible photocatalyst and a low-cost laser to grow carbon nano- and microstructures at low temperature.

The approach produces carbon features with no chemical or metallic contaminants. The dimensions of the features can be tuned from few nanometers to several millimeters in diameter and length. The patterning feature allows to position adjacent structures with pitches below 100 micrometers. Larger arrays can be patterned on any substrate coated with the photocatalyst, even in loose form.

Specifically, the method disclosed allows for the production of carbon structures having tuned and tailored properties using low-cost materials. The carbon structures produced capable of being grown in a short period of time with considerably lower energy requirements than traditional methods. The structures which are formed are free of contaminants have a very fine morphology that cannot be achieved with 3D printing and carbonization.

Additional customization can be achieved by modifying the catalyst and/or the light source. Atoms other than carbon can be introduced into the carbon structures by varying the environment of the reactor during growth. This will allow tuning of optical and electrical properties during growth.

In certain embodiments, the diameters of the carbon structures can be regulated by adjusting the size, shape, and duration of the light source. In certain embodiments, the diameter of the carbon structures which can be produced vary from about 10 nm to about 50000 nm. In certain other embodiments, the diameter of the carbon structures which can be produced vary from about 100 nm to about 25000 nm; from about 500 nm to about 12500 nm; or from about 1000 nm to about 10000 nm.

### Light Source

The disclosed method utilizes light to control the growth of the carbon structures. The growth process can be tuned at different wavelengths in the visible range, which makes it possible to design processes taking advantage of various lasers or solar illumination.

Suitable light sources include, but are not limited to, a CO laser, a CO₂ laser, a Nd:YAG laser, a frequency doubled Nd:YAG laser, an argon fluoride laser, a xenon chloride laser, a xenon fluoride laser, a helium cadmium laser, a dye laser, a copper vapor laser, an argon laser, a helium neon laser, a krypton laser, a ruby laser, a Ti:sapphire laser, laser diodes, an alexandrite laser, a hydrogen fluoride laser, an erbium:glass laser, or solar illumination.

### Photocatalyst

The disclosed method utilizes a non-noble metal catalyst to produce the carbon structures. The catalyst is obtained by introducing defects in a base material, such as hexagonal boron nitride (h-BN), or materials derived from aluminum diboride (AlB₂). The introduction of defects increases the catalytic activity of the base material. These defects are introduced using methods such as those disclosed in U.S. Pat. Nos. 10,329,233; 9,725,395; or 9,624,154. The local environment of the boron atom can be further modified (strain, doping, etc) to vary the activation properties resulting in different properties of the carbon growth.

In the case of h-BN, pristine sheets of h-BN are exceptionally robust and chemically inert. Hydrogen absorption on the surface of pristine h-BN is endothermic with respect to dissociation but may be enhanced by introducing vacancies or Stone-Wales-type defects into the h-BN sheet. Defects and delamination can be introduced through any known physical, chemical, thermal and/or electronic process. In one particular embodiment, such defects can be introduced through the application of mechanical force. In particular embodiments, the defect is selected from the group consisting of Stone-Wales defects, B/N defects, boron substituted nitrogen, nitrogen substituted for boron, carbon substituted for nitrogen, carbon substituted for boron, boron vacancy, nitrogen vacancy, and combinations thereof.

In certain embodiments, the catalyst can be a heterogeneous catalyst such as a heterogeneous dehydrogenation catalyst.

In certain embodiments, the catalysts include, but are not limited to, defect laden hexagonal boron nitride

In certain embodiments, the catalyst can be a two-dimensional catalyst which does not contain a defect but does include other variances. Such variances can be achieved by introducing vacancies in the catalyst material, adding additional doping agents, inducing strain or by utilizing different stacking arrangements such as placing a BN layer or a 2D boron layer on top of another 2D material with selected angle (Moire pattern). In such embodiments, the catalyst may be a two-dimensional boron catalyst, including, but not limited to, a two-dimensional boron catalyst produced through chemically etching aluminum diboride.

### Carbon Source

The disclosed method utilizes a carbon source which is reduced to produce a carbon nanostructure. The carbon source is not particularly limited and may include, without limitation a small molecule or biomass source. In certain embodiments, the carbon source is methane, ethane, propane, propene, allene, propyne, cyclohexene, carbon monoxide, or a hydrocarbon with less than 10 carbon atoms in its structure. In certain embodiments, the carbon source is provided as a gaseous environment in which the exposure to the light source is performed.

### Patterning and Applications

The disclosed method can be used to produce carbon materials for use in a number of ways, including but not limited to use: as interconnects for (nano)electronics ; as microelectrodes for 3D sensor systems used in biotechnology; as electrodes for batteries and supercapacitors; as emitters for LED-type applications and for sensing applications; as active materials for sensor applications; for solar cells; and in electronic devices such as diodes and transistors.

The patterning can be achieved in the form of a small benchtop system, such as a 3D printer device, holding a simple environmentally controlled chamber to produce patterns of carbon structures. In some embodiments the method achieved is in the form of a printing machine adapted for the growth of carbon structures.

Patterning can be done on loose powder or on coated surfaces, including flexible surfaces. The surfaces which can be coated are not limited and include glass, silicon, fabric.

The patterning can be implemented to allow the patterning of custom designs for production of targeted shapes and arrays.

### EXAMPLES

### Example 1

Pristine h-BN powder was dried in vacuo at 400° C. for 12 h to remove moisture and stored in an argon-filled glovebox. Defects were induced in the material through ball milling with zirconia and media. Typically, a mixer/mill was utilized to supply the mechanical force for defect generation. Batches consisting of 2.0 g of h-BN were produced using one 19.05-mm-diameter zirconia ball weighing ˜26.6 g (ball to powder ratio of 12.8:1) and milling for 120 min under inert conditions. Freshly produced dh-BN showed a color change from white to off-white and retained this change as long as they were stored under inert conditions.

Glass slides were coated with the material produced and held in a pressurized chamber with a sapphire window that allowed laser light to be focused on the materials surfaces while under an atmosphere of the desired carbon source. It was found that propene, allene, propyne, cyclohexene and carbon monoxide were effective carbon sources.

### Example 2

Methane was captured and utilized as a carbon source for building carbon structures with the process described here. A catalyst with high boron content was produced through chemical etching of aluminum diboride (AlB₂) at ambient temperature. The material produced had a reduced aluminum content. X-ray fluorescence analysis indicated a composition of AlB_{6.5}. The boron produced was non-equilibrium 2-dimensional boron in a puckered hexagonal structure.

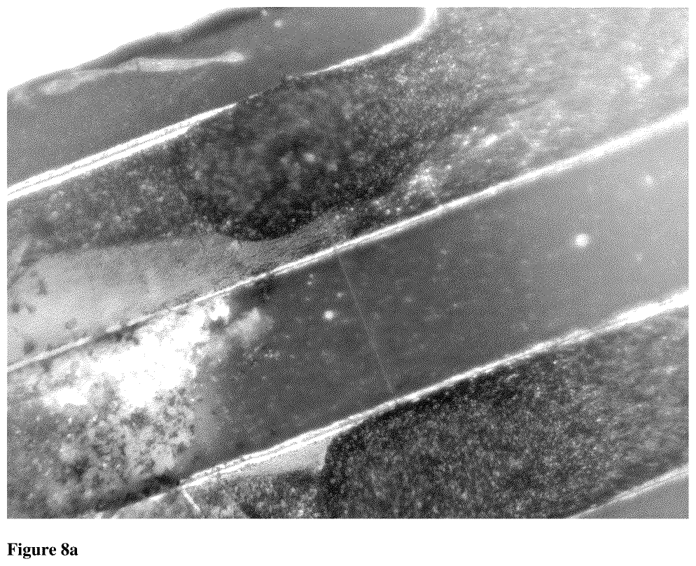

This resultant catalyst was active for methane dehydrogenation under 405 nm light illumination or 532 nm illumination with only carbon realized as the solid product (FIG. 7).

### Example 3

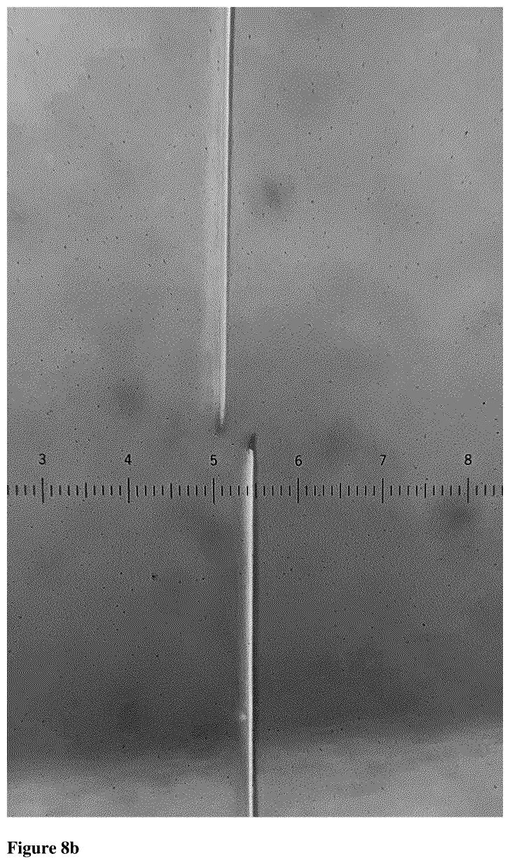

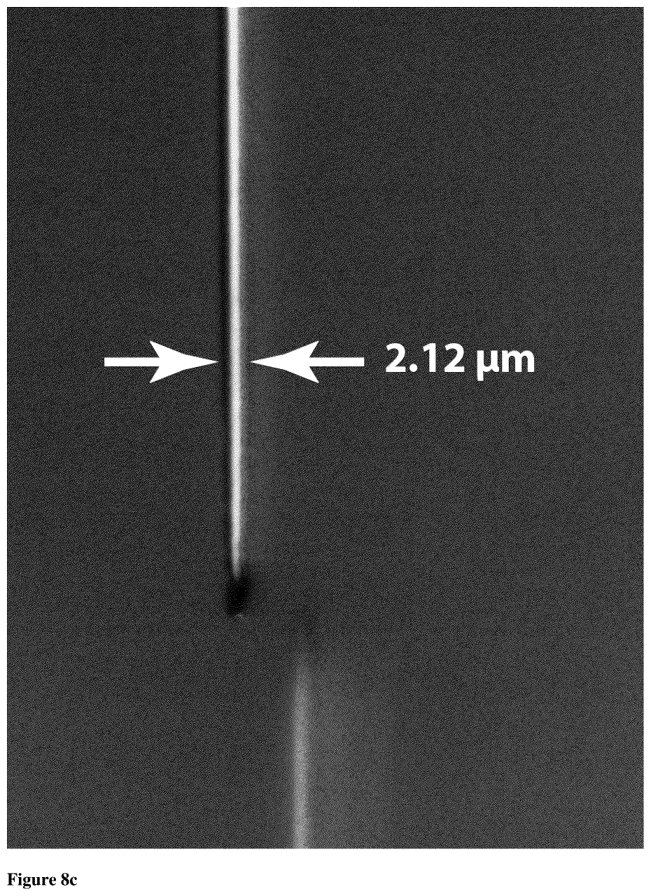

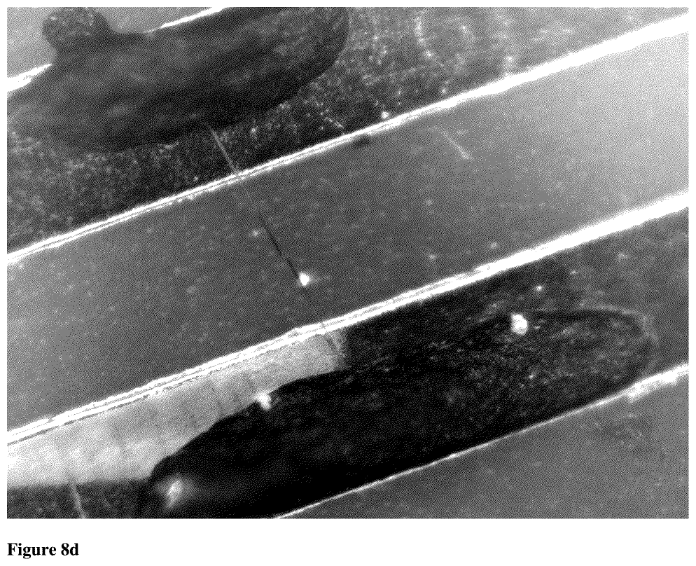

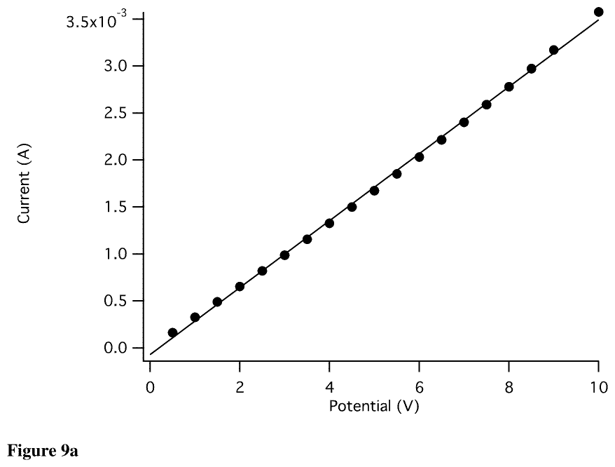

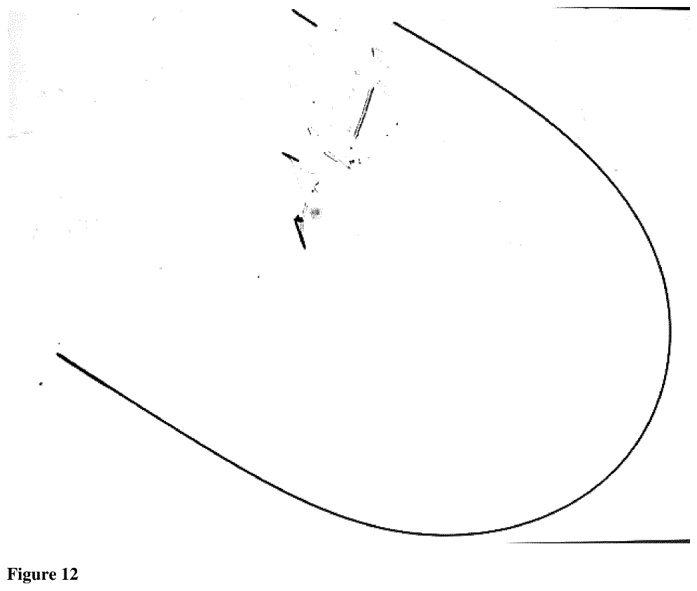

In accordance with Examples 1 and 2, a carbon rod was produced and analyzed for various electrical properties. The rod is shown in FIG. 8a. Catastrophic failure of the rod resulted in a breakage after passing current through the rod above the damage threshold (FIGS. 8b, 8c, and 8d). Nevertheless, prior to testing, the rod was highly flexible as shown in FIG. 12.

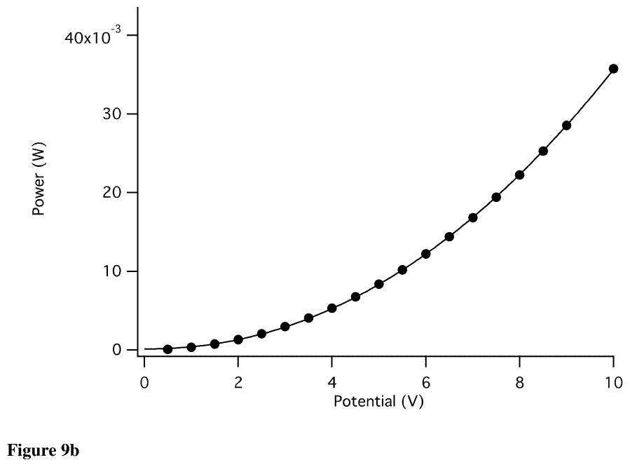

FIGS. 9a and 9b show the DC electrical properties of the rod.

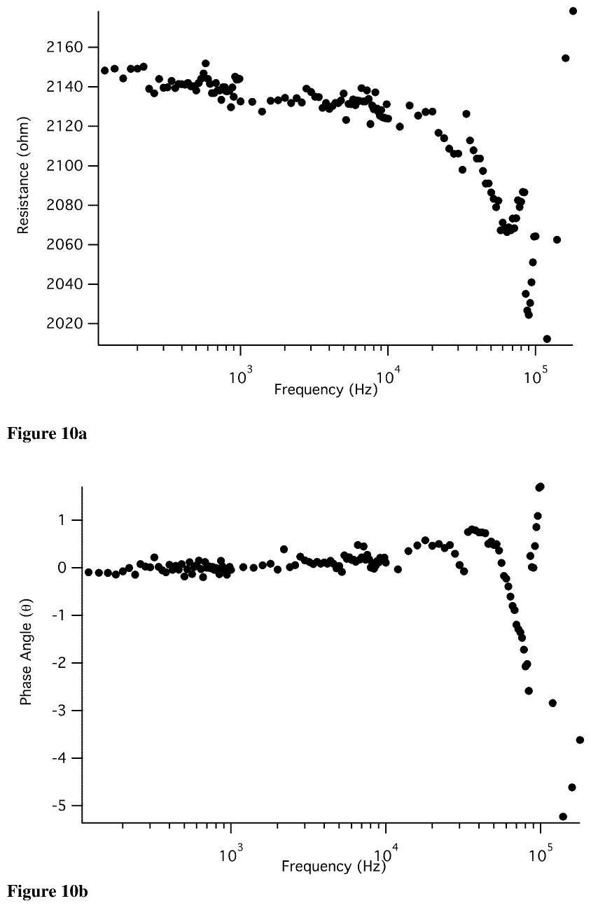

FIGS. 10a and 10b show the AC electrical properties of the rod. The data showed that the rod had resistive, inductive, and capacitive properties and behaved as an RLC circuit.

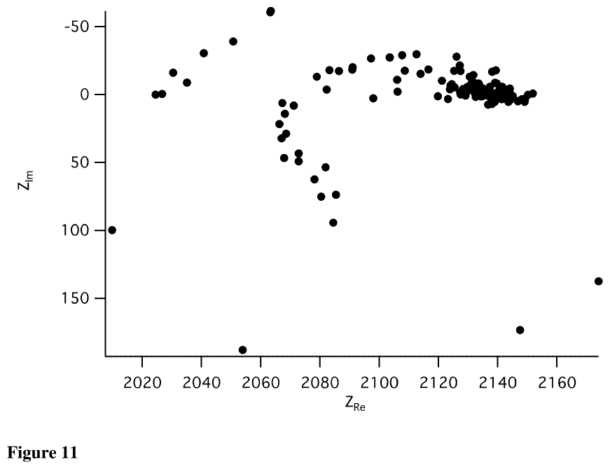

FIG. 11 shows the complex impedance spectrum of the rod.

### Incorporation by Reference

The entire contents of all patents, published patent applications and other references cited herein are hereby expressly incorporated herein in their entireties by reference.

### List of References

1. Tetard, Blair et al. “PHOTOCHEMICAL TRANSFORMATION USING ENGINEERED METAL-FREE HEXAGONAL BORON NITRIDE” Application No. 63/219,333
2. Blair, R. G., “Chemical reduction using a catalyst comprising frustrated lewis pairs,” U.S. Pat. No. 10,329,233, 2019
3. Blair, R. G, “Heterogeneous Metal-Free Catalyst,” U.S. Pat. No. 9,725,395, 2017
4. Blair, R. G, “Heterogeneously Catalyzed Chemical Reduction of Carbon Dioxide,” U.S. Pat. No. 9,624,154, 2017

### Equivalents

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A method for producing a carbon nanostructure having controlled dimensions comprising:
a.) providing a two-dimensional catalyst having one or more variances; and
b.) exposing the surface of the catalyst to a light source in the presence of a carbon source to produce a carbon nanostructure at the site of exposure.

2. The method for producing a carbon nanostructure having controlled dimensions according to claim 1, wherein the two dimensional catalyst having one or more variances is a defect laden hexagonal boron nitride (h-BN), a two-dimensional boron produced through chemically etching an aluminum diboride (AlB₂) material, or a two-dimensional boron-based material in which the local environment of the boron atom includes variances produced by inclusion of a doping agent, induced strain, stacking with additional catalysts.

3. The method for producing a carbon nanostructure having controlled dimensions according to claim 1, wherein the light source is a CO laser, a CO₂ laser, a Nd:YAG laser, a frequency doubled Nd:YAG laser, an argon fluoride laser, a xenon chloride laser, a xenon fluoride laser, a helium cadmium laser, a dye laser, a copper vapor laser, an argon laser, a helium neon laser, a krypton laser, a ruby laser, a Ti:sapphire laser, laser diodes, an alexandrite laser, a hydrogen fluoride laser, an erbium:glass laser, or solar illumination.

4. The method for producing a carbon nanostructure having controlled dimensions according to claim 1, wherein the carbon source is methane, ethane, or propane, propene, allene, propyne, cyclohexene carbon monoxide, or a hydrocarbon with less than 10 carbon atoms in its structure.

5. The method for producing a carbon nanostructure having controlled dimensions according to claim 1, wherein the light source is housed in a printing apparatus capable of producing a pattern of carbon nanostructures.
